(19) United States
(12) Patent Application Publication
(10) Pub. No.: US 2013/0048570 A1
(43) Pub. Date: Feb. 28, 2013

(54) CONCENTRATION OF SUSPENSIONS

(71) Applicants: Paul Stocks, West Yorkshire Bradford (GB); Ian John Flanagan, South Yorkshire (GB); Gregor Brodt, Heppenheim (DE); Stephen Adkins, Petting (DE)

(72) Inventors: Paul Stocks, West Yorkshire Bradford (GB); Ian John Flanagan, South Yorkshire (GB); Gregor Brodt, Heppenheim (DE); Stephen Adkins, Petting (DE)

(73) Assignee: BASF SE, Ludwigshafen (DE)

(21) Appl. No.: 13/640,189

(22) PCT Filed: Apr. 8, 2011
(86) PCT No.: PCT/IB11/51516

§ 371 Date: Nov. 14, 2012

(30) Foreign Application Priority Data
Apr. 9, 2010 (EP) 10159541.1

(51) Int. Cl. C02F 9/04; C02F 101/10; C02F 101/20

(52) U.S. Cl. 210/721

(57) ABSTRACT

Gravity sedimentation of a first aqueous suspension of solid particles in a vessel results in formation of a second aqueous suspension of solid particles in the present invention. The process involves adding at least one organic polymeric flocculant to the first aqueous suspension to form a suspension of flocculated solid. The flocculated solids settle to form a bed of consolidated solids. Introducing an effective amount of an agent into the bed of consolidated solids or into the flocculated solids that are settling leads to formation of the second aqueous suspension. The second aqueous suspension of solid particles has a higher solids content than the first aqueous suspension of solid particles. The agent is a free radical agent or an oxidizing agent.

The present invention relates to an improved flocculation process for the concentration of suspensions. In particular flocculated solids can be settled to form a bed in which higher solids and/or reduced yield stress can be achieved.

It is known to concentrate suspensions of solids in aqueous liquids by use of flocculants resulting in flocculation of the solids which facilitates the separation of the solids from the liquid. In many processes the flocculated solids settle to form a bed by sedimentation. In other processes separation can be facilitated by mechanical dewatering, for instance in pressure filtration, centrifugation, by belt thickeners and belt presses.

The types of flocculant added to the suspension will often depend upon the substrate. Generally suspensions tend to be flocculated by high molecular weight polymers. Examples of this are described in WO-A-9314852 and U.S. Pat. No. 3,975,496 regarding the flocculation of mineral suspensions such as red mud. Other disclosures of high molecular weight polymeric flocculants include U.S. Pat. No. 6,447,687, WO-A-0216495 and WO-A-02083258 dealing with the flocculation of sewage sludge. It is known to add other chemical additives sometimes in order to condition the suspension. For instance suspensions may be first coagulated by a high charged density polymeric coagulant such as polyDADMAC or inorganic coagulants including ferric chloride.

Other additives are also use in conditioning of suspensions. For example peroxides are sometimes added to suspensions such as sewage sludges or other suspensions containing organic material in order to remove reducing agents in order to reduced odours, gas formation or prevent putrefaction. In general the peroxides or oxidising agents tend to be added in order to remove harmful or unwanted substances or other materials contained in the suspension. Generally the amount of peroxides added is only sufficient to remove the unwanted substances and materials and generally peroxides or other oxidising agents are included in relatively small amounts.

Examples of adding peroxides to sewage sludge are described in JP56150481. Peroxides or oxidising agents may also be added to other suspensions for similar reasons including treating dredged material to remove contaminants as described in US 2003 121863 and JP 10109100. JP 11156397 describes a process for flocculating mud using non-ionic and anionic polymers in which the mud has been pretreated with an oxidising agent.

U.S. Pat. No. 6,733,674 describes a method of dewatering sludge by adding an effective amount of one or more cellulolytic enzymes and one or more oxidants and one or more flocculants to form a mixture in water which is coagulated and flocculated followed by separation of solids from the water. The examples seem to indicate a significant time elapsed between oxidant addition and flocculation. The enzymes appeared to be present in order to degrade material contained in the sludge.

Suspensions are frequently concentrated in a gravity thickener vessel. A continual flow of the suspension is typically fed into the thickener and treated with a flocculant. The flocculated solids thus formed settle to form a bed of solid underflow and supernatant aqueous liquid flows upwards and is usually removed from the thickener vessel through a perimeter trough at the water surface. Normally the thickener vessel has a conical base such that the underflow can easily be removed from the centre of the base. In addition a rotating rake assists the removal of the underflow solids. A typical process for concentrating suspensions in a gravity thickener is described in U.S. Pat. No. 4,226,714.

Various suspensions can be concentrated in gravity thickeners, including suspensions of organic solids such as wastewater, sewage and sewage sludges. It is also commonplace to thicken or dewater mineral suspensions using gravity thickeners.

In a typical mineral processing operation, waste solids are separated from solids that contain mineral values in an aqueous process. The aqueous suspension of waste solids often contains clays and other minerals, and is usually referred to as tailings. These solids are often concentrated by a flocculation process in a thickener and settle to form a bed. Generally it is desirable to remove as much water from the solids or bed in order to give a higher density underflow and to recover a maximum of the process water. It is usual to pump the underflow to a surface holding area, often referred to as a tailings pit or dam, or alternatively the underflow may be mechanically dewatered further by, for example, vacuum filtration, pressure filtration or centrifugation.

U.S. Pat. No. 5,685,900 describes a selective flocculation process for beneficiating a low brightness fine particle size kaolin in order to reduce a higher brightness kaolin clay. The process involves a classification step to recover the kaolin fraction wherein the particles are at least 90% by weight below 0.5 μm. The recovered fraction is then subjected to a bleaching step to partially bleach organic discolorants. The resulting slurry is selectively flocculated using a high molecular weight anionic polyacrylamide or acrylate acrylamide copolymer. This flocculation step forms a supernatant phase which is highly concentrated with contaminant titania and a flocculated clay phase which is devoid of titania that contains the discolorants. The flocs are then treated with gaseous ozone in order to oxidising the remaining discolouring organics and also destroy the flocculant polymer in order to restore the kaolin to a dispersed state. This is said to be achieved by passing the flocculated solids through an ozonation step, preferably using a high shear pump.

Similar disclosures are made in WO 2004 071 989 and US 2006 0131243.

WO 2005 021129 discloses controlling the condition of a suspension of solid particles within a liquid including applying 1 or more stimuli to the suspension. In this disclosure conditioning is preferably reversible and involves flocculation and/or coagulation in which inter particle forces may be attractive or repulsive between the solid particles within the liquid. The stimulus may be one or more chemical additives and may for instance be a stimulus sensitive polyelectrolyte which can be absorbed on the surface of the suspended particles in sufficient quantity to create steric or electrostatic repulsion between the particles. In one instance a polyelectrolyte may be substantially insoluble at pH values where it is substantially uncharged thereby to effect flocculation of the suspension. Polyelectrolytes that are responsive to a temperature stimulus are also described. Reference is also given to a method of controlling the consolidation of a bed of solid particles within a liquid by applying one or more stimuli to the bed. Each stimulus effects reversibly operable conditioning between an initial state, prevailing prior to said conditioning, applying one or more stimuli and a conditioned state resultant from said one or more stimuli. The processes described bring about improvements in certain solids liquids separation activities.

JP 11-46541 describes a temperature sensitive hydrophilic polymer added to a suspension of particles below a transition temperature whereupon flocs are formed by absorbing and crosslinking particles as a conventional flocculant. The mixture is heated to above the transition temperature and the absorbed polymer becomes hydrophobic and the suspended particles are rendered hydrophobic and form flocs by hydrophobic interaction. Appropriate external pressure is applied at this time and the particles are readily realigned and water between the particles is expelled by the hydrophobicity of the particles.

JP 2001 232104 describes a process similar to JP 11-46541 but using improved temperature sensitive flocculants that are ionic temperature sensitive polymer as opposed to non-ionic polymers which a absorb onto suspended particles and when the polymer becomes hydrophobic at temperatures about the transition point there are strong hydrate layers around the ionic groups but hydrated layer adhesion between the polymers is prevented by hydrophobic interaction.

Bertini, V. et. al. Particulate Science and Technology (1991), 9(3-4), 191-9 describes the use of multifunctional polymers for the pH controlled flocculation of titanium minerals. The polymers are radical vinyl copolymers containing catechol functions and acrylic acid units. The polymers can change their effect from flocculating to dispersing or inert and vice versa by changing pH.

The pH or temperature sensitive flocculants in principle provide control over the flocculation state of a suspension. However, the choice of flocculant would need to be appropriate for the particular suspension or bed that is to be flocculated and at the same time be responsive to a particular stimulus to bring about the reversibly operable conditioning. In some cases it may be difficult to find the right choice of flocculant.

Frequently some water will be trapped in the flocculated solids and this water is often difficult to release and therefore held in the bed. Whilst pH and temperature responsive flocculants may assist with this problem it is often difficult to achieve satisfactory flocculation across a wide range of substrates.

In processes involving gravity thickeners it is desirable to operate such that the bed has the highest possible solids capable of being removed from the thickener as an underflow. Normally the limiting factor is the ability of the rake in the thickener to move the sedimented solids. It would therefore be desirable to provide a process which increases the rate of separation of the solids from the suspension and removal of the underflow.

WO 2007 082797 describes a process of concentrating an aqueous suspension of solid particles by addition of organic polymeric flocculant to the suspension in order to form flocculated solids. The flocculated solids settle to become a more concentrated suspension. An agent selected from any of free radical agents, oxidising agents, enzymes and radiation is applied to the suspension prior to or substantially simultaneously with adding the organic polymeric flocculant and/or the organic polymeric flocculant and the agents are both added to the suspension in the same vessel. The process brings about a significant reduction in yield stress of the concentrated suspension or allows a significant increase in the solids content of the concentrated suspension for a given yield stress.

However, there is a need to further improve the process.

Thus according to the present invention we provide a process of forming a second aqueous suspension of solid particles (15) by gravity sedimentation of a first aqueous suspension of solid particles (14) in a vessel (13), comprising the steps of,
adding at least one organic polymeric flocculant (12) to the first aqueous suspension of solid particles (14) thereby forming a suspension of flocculated solids (11),
which flocculated solids settle to form a bed of consolidated solids (5),
introduction of an effective amount of an agent, into the i) bed of consolidated solids (5) or ii) the flocculated solids that are settling (11), in order to form the second aqueous suspension (15),
in which the second aqueous suspension of solid particles (15) is of higher solids than the first aqueous suspension of solid particles (14),
and in which the agent is selected from the group consisting of free radical agents and oxidising agents,
   wherein the agent is introduced in accordance with the means described below.

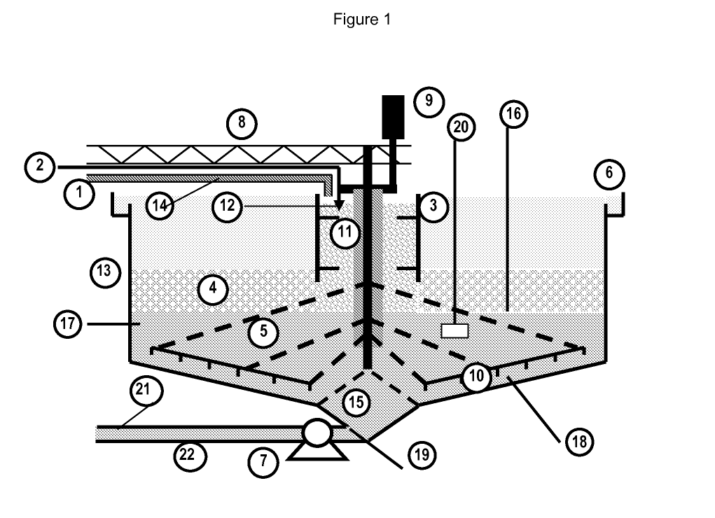

In FIG. 1 the diagram represents a standard gravimetric thickener vessel comprising the following components: slurry feed pipe (1) which conveys the first suspension (14) into the feedwell (3) of the vessel (13); and organic polymeric flocculant (12) is added through flocculant feed line (2); the feedwell (3) is indicated as being a baffled feedwell; a high concentration of settling flocculated solids (11) is shown in the baffled feedwell; clarification zone (4) is indicated where the flocculated solids are settling and becoming separated from aqueous fluid; above the layer indicated as the clarification zone a layer is indicated showing a reduced concentration of settling flocculated solids; above this layer of a reduced concentration of flocculated solids an essentially low solids aqueous fluid is shown which flows over the overflow launder (6); below the clarification zone (4) a consolidated bed of solids (5), which forms the second aqueous suspension of solids (15), is indicated at the lower end of the vessel; the consolidated bed of solids forms an underflow (21) which is fed from the vessel through a conduit (22) at the base of the vessel; an underflow pump (7) is present to assist the removal of the underflow from the vessel; a bridge (8) is present to allow access to the feedwell and rakes (10) and the range drive mechanism (9). The agent may be introduced through one or more conduits (16) entering through the top of the vessel; or through one or more apertures or conduits (17) in the side walls of the vessel; or one or more apertures or conduits (18) in the base of the vessel; or one or more apertures or conduits (19) in the feed line conveying the bed of consolidated solids from the base of the vessel, for instance between the base of the vessel and a pump; or through one or more sparges (20).

The means with which the agent is introduced into the bed of consolidated solids or the flocculated solids that are settling may include one or a multiplicity of apertures in the side walls of the vessel to which the agent can be introduced. Instead of or as well as apertures in the side walls of the vessel it may be desirable to include conduits which pass through the side walls of the vessel and penetrate into the bed of consolidated solids and/or the settling flocculated solids. It may also be desirable for the means to include one or more apertures or conduits in the base of the vessel through which the agent is introduced. Such means may extend into the bed of consolidated solids and/or the settling flocculated solids. It may also be desirable for the means to include one or more conduits which enter through the top of the vessel, which conduits may extend into the bed of consolidated solids and/or the settling flocculated solids. Such one or more conduits may enter and run down the inner wall and base of the vessel or alternatively may be positioned such that they enter at any point from the top of the vessel. It may also be desirable for such conduits to run alongside other components used in the vessel, for example the rakes.

A particularly suitable means for introducing the agent is one or more rakes for conveying the agent. Suitably the one or more rakes would be hollow or otherwise comprise a conduit which allows the passage of the agent. We have found that this means is particularly effective at introducing the agent into the bed of consolidated solids. Furthermore, the action of the rakes in releasing the agent as they move throughout the bed of consolidated solids has been found to be a particularly effective way of forming the second aqueous suspension. This action of the rakes appears to efficiently distribute the agent throughout the bed of consolidated solids without adversely disturbing or re-dispersing any of the solids.

A further means by which the agent may be introduced into the bed of consolidated solids or settling flocculated solids includes one or more sparges. The sparges appear to allow a fine distribution of the agent as it is introduced into the bed of consolidated solids or the settling flocculated solids. It may also be desirable for one or more sparges to be used in conjunction with the other means of introducing the agent, for instance using sparges in combination with conduits which penetrate into the bed of consolidated solids or the settling flocculated solids.

Desirably the means for introducing the agent should facilitate the distribution of the agent throughout the bed of consolidated solids or the flocculated solids that are settling.

Typically the process will be directed to dewatering processes and thickening processes and the like.

In the process the flocculated solids are allowed to settle to form a bed of consolidated solids which may also be termed sediment. Typically the process involves sedimentation in a vessel which is a gravity thickener and a sediment or bed is removed from the base of the vessel as an underflow.

We have found that the process according to the present invention provides a significant improvement in reduced yield stress or increased solids for a given yield stress can be achieved. In addition a significant increase in the release of aqueous liquid can be observed.

The exact mechanism by which the agent acts on the bed of consolidated solids or the settling flocculated solids is not entirely understood. However, it would appear that the action of the agent on the flocculated solids gives rise to the second aqueous suspension which is a bed of consolidated solids which would seem to have an altered state by comparison to the bed of consolidated solids that had not been so treated by the agent. It would appear that the chemical interaction between the flocculant and the solids may be permanently altered as a result of the action of the agent. It would also appear that the flocculated structure may be diminished or collapsed to such an extent that the solids occupy a smaller volume. We also find that this is a more concentrated aqueous suspension which is formed by the action of the agent may have improved flow characteristics. It is apparent that the yield stress of this more concentrated second aqueous suspension may be significantly reduced for a given solids content. Furthermore, it is possible to increase the solids content for any given yield stress value.

In one preferred form the agent brings about a reduction in the yield stress of a layer of solids formed from the action of the organic flocculant. More preferably the layer of solids should be at least 30% below the yield stress of a layer of solids at an equivalent solids content without the addition of the agent. Thus the agent desirably brings about a reduction in the yield stress of the layer or bed of consolidated solids it enables higher solids to be achieved and an increased removal of the underflow. Preferably the reduction in yield stress will be at least 50% below the yield stress of a layer of solids at an equivalent solids content without the addition of the agent. More preferably the reduction in yield stress will be at least 60 or 70% and often at the least 80 or 90%.

We have also found that the yield stress can be reduced below the yield stress of a layer of solids at an equivalent solids content that had not been flocculated and without the addition of the agent. Previously there had been a generally accepted view that sedimentation of solids in the absence of flocculation would achieve the lowest yield stress. It had been generally believed that a process involving flocculation would always result in a higher yield stress than in the absence of the flocculant because the flocculant would tend to hold the sedimented solids in a structure that would tend to increase the yield stress. The method of introducing the agent according to the present invention is particularly effective at achieving this benefit.

In a preferred form of the process the flocculated solids settle to form a bed and water is released from the suspension and in which we have found that the introduction of the agent into the bed of consolidated solids by the means according to the present invention brings about an increase in the water released from the suspension. Consequently, we find that this increase in water released is also accompanied by an increase in the solids.

The process of the present invention has been found to enhance the concentration of a suspension, by gravity sedimentation. In this sense the rate of consolidation of separated solids is increased. In addition the mobility of concentrated phase, i.e. settled or sedimented solids, can be significantly improved.

The agent may be one or more chemical compounds selected from the group consisting of free radical agents and oxidising agents.

It has been found that the incorporation of a free radical agent or oxidising agent into the flocculation process has resulted in a more rapid compaction phase, and/or reduced viscosity of the layer or bed of solids e.g. sediment at corresponding solids contents such that a higher solids content can be achieved without exceeding the maximum viscosity that the equipment carrying out the removal process can tolerate.

Suitable free radical agents include chemical compounds selected from the group consisting off ferrous ammonium sulphate, ceric ammonium nitrate etc.

It may also be desirable to use activators in conjunction with the free radical agents which in some cases may accelerate the radical generation. Typically such activators include amino carboxylates and diamines, cupric EDTA (ethylene diamine tetra acetic acid) and reducing sugars such as fructose and lactose.

Any conventional oxidising agent may be used. Oxidising agents may be chemical substances selected from the group consisting of chlorine, transition metal or other metal compounds in a high oxidation state, such as chromium, manganese, iron and copper compounds each of which include substances that are powerful oxidizing agents, tBHP (tertiary butyl hydro peroxide), sodium sulphite , bi-sulphite compounds, ammonium per sulphate, sodium perborate, sodium hypopchlorite and ozone.

The use of ozone, peracetic, perborates, percarbonate and persulphates have been found to be particularly effective for oxidizing purposes.

Preferred agents for use in present invention are peroxides and ozone. A particular preferred peroxide is hydrogen peroxide. Preferably the hydrogen peroxide will be in an aqueous solution containing at least 20% hydrogen peroxide, preferably at least 30% as much as 50 or 60% or more. When ozone is used it is preferred that this is in the form of ozone water. Typically the ozone water would have a concentration of at least 0.1 ppm and usually at least 1 ppm. The concentration may be as much as 1000 ppm but usually effective results are obtained at lower concentrations, such as up to 500 ppm or even up to 100 ppm. Often the concentration will be in the range of between 5 ppm and 50 ppm, for instance between 10 ppm and 40 ppm, especially between 20 ppm and 30 ppm.

The amount of agent will vary according to the specific process conditions, the type of substrate and flocculant. The agent preferably should be introduced at a dose in an amount of at least 1 ppm based on weight of agent on volume of the first aqueous suspension. The agent can be effective at low levels for example between 1 and 10 ppm. Generally the agent will be added in an amount of from at least 100 ppm and in some cases may be at least 1000 ppm based on the volume of the first suspension. In some cases it may be desirable to add significantly higher levels of the agent, for instance as much as 40,000 or 50,000 ppm or higher. Effective doses usually will be in the range between 150 and 20,000 ppm, especially between 1000 and 15,000 ppm.

More preferably the increase in water released from the layer or bed and the increased solids of the layer or bed is also accompanied by a decrease in yield stress. Preferably we find that the yield stress of the layer or bed is less than a layer or bed at equivalent solids content in which the flocculated solids are not exposed to the agent.

It is known that in general solids in suspensions will often settle without the addition of flocculent. The flocculant brings about bridging flocculation of the solids and increases the rate at which the solids settle to form a bed. Thus in conventional gravity thickening situations, improved rate of free settlement and initial compaction are achieved by the use of polymeric flocculants and optionally coagulants. In such a process the individual solid particles tend to gather together to form aggregates which have a more favorable density to surface area ratio. These aggregates can settle to form a compacted bed from which water can be further removed by upward percolation. In this way the bed progressively increases in solids content over an extensive period of time until the desired solids concentration in the bed is reached and material in the bed can be removed.

Unfortunately, in general the yield stress of the flocculated settled solids in conventional processes tends to be significantly higher than the settled solids in the absence of the flocculant. This tends to make the removal process of raking and pumping progressively more difficult. On the other hand it would not be practical to concentrate a suspension in the absence of flocculant since this would take an extremely long time, especially in a gravimetric thickener which relies upon free sedimentation.

In the process according to the invention we have found that a more rapid compaction phase can be achieved. In addition it has been found that the present process tends to result in a significantly reduced viscosity or yield stress of the layer of solids or bed as a result of treatment by the agent. In particular we find that the yield stress is not only lower than the equivalent process in the absence of the agent, but the yield stress can be as low as or lower than settled solids in the absence of the flocculant. In some cases we find that the process results in a layer or bed of solids having a yield stress significantly below that of settled solids in the absence of flocculant. This unexpected property of the settled solids facilitates the ease of removal of a solids underflow whilst at the same time ensuring rapid settling of the solids. Furthermore, it is preferred that the process is operated by allowing the solids content of the consolidated bed to increase significantly above that which can be tolerated by the equipment in the absence of the agent. In this sense the consolidated bed may still be operated at the maximum yield stress for the equipment but in which the solids content is significantly higher than the bed in a process without the agent.

The yield stress of the layer of solids including sedimented bed will vary according to the substrate. Typically the maximum yield stress of a sedimented bed that can be tolerated by conventional equipment is usually no more than 250 Pa. Within capabilities of the existing equipment it would not be possible to increase the solids using the conventional process since the yield stress would be too high. The process of the invention employing the agent has been found to reduce the yield stress by at least 10% and usually at least 50% and in some cases as much as 80 or 90% or higher. On the other hand the solids content of the layer or bed produced according to the invention can be allowed to increase by at least 5% and sometimes more than 10% without exceeding the maximum yield stress that can be tolerated by the equipment. In some cases it may be possible to increase the solids by up to 15 or 20% or more in comparison to a layer or bed having the same yield stress obtaining by the equivalent process but in the absence of the agent.

The actual weight percent underflow solids that can be achieved with acceptable yield stress varies considerably dependent upon the constituent and particle size of the suspended solids, and also the age and sophistication of the settling equipment. It may be as low as around 12% (typically Florida phosphate slimes) but is usually between around 20% and 50%.

The Yield Stress is measured by Brookfield R/S SST Rheometer at an ambient laboratory temperature of 25° C. using the RHEO V2.7 software program in a Controlled Shear Rate mode. Rotation of a Vane spindle (50_{—}25 vane at a 3 to 1 vessel sizing) in 120 equal step increases of 0.025 rpm generate a progressive application of increased Shear Rate.

Yield Stress is defined as the maximum shear stress before the onset of shear. The Yield Stress is calculated by linear regression of the 4 measurement points with Shear Rate >0.1 1/s and subsequent calculation of the intercept of the axis of Tau (Pa) for Shear Rate=0.

The invention is applicable to any solids liquid separation activity in which solids are separated from a suspension by gravity sedimentation in a vessel. Particularly preferred processes involve subjecting the suspension to flocculation in a gravimetric thickener. In such a process the solids form a compacted layer of concentrated solids, which in general will be significantly higher than in the absence of the agent.

The second aqueous suspension resulting from the process may form an underflow which would normally be removed from the vessel. In many instances the second aqueous suspension forms an underflow which is then transferred to a disposal area. Alternatively the underflow may be transferred to a further processing stage, such as filtration. The further processing stage would typically be a further mineral processing stage, such as filtration or further extraction of mineral values.

As indicated previously the invention is applicable generally to solids liquid separation processes which involve gravity sedimentation in a vessel. Thus the suspension may comprise organic material including for instance sewage sludge or cellular material from fermentation processes. The suspension may also be a suspension of cellulosic material, for instance sludges from papermaking processes. Preferably the suspension is an aqueous suspension comprising mineral particles.

In a more preferred aspect of the invention the process involves the treatment of aqueous suspensions resulting from mined mineral processing and other mining wastes, for instance from carbon based industries such as coal and tar sands, comprising suspensions of mineral particles, especially clays. Thus in this preferred aspect of the process the aqueous suspension is derived from mineral or energy processing operations and/or tailings substrates. By energy processing operations we mean preferably processes in which the substrate involves the separation of materials useful as fuels.

A particularly preferred aspect of the process involves suspensions selected from mining and refining operations the group consisting of bauxite, base metals, precious metals, iron, nickel, coal, mineral sands, oil sands, china clay, diamonds and uranium.

Preferably suspended solids in the suspension should be at least 90% by weight greater than 0.5 microns. Frequently the particles in suspension will be at least 90% by weight at least 0.75 microns and preferably at least 90% by weight at least one or two microns. Typically suspended particles may have a particle size at least 90% by weight up to 2 mm and usually at least 90% by weight within the range above 0.5 microns to 2 mm. Preferably suspended particles will be at least 90% by weight up to 1 mm or more preferably at least 90% by weight up to 750 microns, especially at least 90% by weight within the range of between one or two microns and one or two millimeters.

The suspensions will often contain at least 5% by weight suspended solids particles and may contain as much as 30% or higher. Preferably suspensions will contain at least 0.25% more preferably at least 0.5%. Usually the suspensions will contain between 1% and 20% by weight suspended solids.

Suitable doses of organic polymeric flocculant range from 5 grams to 10,000 grams per tonne of material solids. Generally the appropriate dose can vary according to the particular material and material solids content. Preferred doses are in the range 10 to 3,000 grams per tonne, especially between 10 and 1000 grams per tonne, while more preferred doses are in the range of from 60 to 200 or 400 grams per tonne.

The aqueous polymer solution may be added in any suitable concentration. It may be desirable to employ a relatively concentrated solution, for instance up to 10% or more based on weight of polymer. Usually though it will be desirable to add the polymer solution at a lower concentration to minimise problems resulting from the high viscosity of the polymer solution and to facilitate distribution of the polymer throughout the suspension. The polymer solution can be added at a relatively dilute concentration, for instance as low as 0.01% by weight of polymer. Typically the polymer solution will normally be used at a concentration between 0.05 and 5% by weight of polymer. Preferably the polymer concentration will be the range 0.1% to 2 or 3%. More preferably the concentration will range from 0.25% to about 1 or 1.5%. Alternatively the organic polymeric flocculant may be added to the suspension in the form of dry particles or instead as a reverse phase emulsion or dispersion. The dry polymer particles would dissolve in the aqueous suspension and the reverse phase emulsion or dispersion should invert directly into the aqueous suspension into which the polymer would then dissolve.

The process according to the invention exhibits improved sedimentation rates. It has been found that sedimentation rate is between 2 and 30 m/hour can be achieved. In addition we find that the process enables greater than 99% by weight of the suspended solids to be removed from a suspension. In addition the process enables an increase in solids sediment concentrations of greater than 10% by weight in comparison to conventional processes operating in the absence of the agent. More preferably reduced sediment yield stress is obtaining compared to the best conventional processes.

The organic polymeric flocculant may include high molecular weight polymers that are cationic, non-ionic, anionic or amphoteric. Typically if the polymer is synthetic it should exhibit an intrinsic viscosity of at least 4 dl/g. Preferably though, the polymer will have significantly higher intrinsic viscosity. For instance the intrinsic viscosity may be as high as 25 or 30 dl/g or higher. Typically the intrinsic viscosity will be at least 7 and usually at least 10 or 12 dl/g and could be as high as 18 or 20 dl/g.

Intrinsic viscosity of polymers may be determined by preparing an aqueous solution of the polymer (0.5-1% w/w) based on the active content of the polymer. 2 g of this 0.5-1% polymer solution is diluted to 100 ml in a volumetric flask with 50 ml of 2M sodium chloride solution that is buffered to pH 7.0 (using 1.56 g sodium dihydrogen phosphate and 32.26 g disodium hydrogen phosphate per litre of deionised water) and the whole is diluted to the 100 ml mark with deionised water. The intrinsic viscosity of the polymers are measured using a Number 1 suspended level viscometer at 25° C. in 1M buffered salt solution.

Alternatively, the organic polymeric flocculant may be a natural polymer or semi natural polymer. Typical natural or semi natural polymers include polysaccharides. This will include cationic starch, anionic starch, amphoteric starch, chitosan.

One preferred class of polymers includes for instance polysaccharides such as starch, guar gum or dextran, or a semi-natural polymer such as carboxymethyl cellulose or hydroxyethyl cellulose.

One preferred class of synthetic polymers includes polyethers such as polyalkylene oxides. Typically these are polymers with alkylene oxy repeating units in the polymer backbone. Particularly suitable polyalkylene oxides include polyethylene oxides and polypropylene oxides. Generally these polymers will have a molecular weight of at least 500,000 and often at least one million. The molecular weight of the polyethers may be as high as 15 million of 20 million or higher.

Another preferred class of synthetic polymers include vinyl addition polymers. These polymers are formed from an ethylenically unsaturated water-soluble monomer or blend of monomers.

The water soluble polymer may be cationic, non-ionic, amphoteric, or anionic. The polymers may be formed from any suitable water-soluble monomers. Typically the water soluble monomers have a solubility in water of at least 5 g/100cc at 25° C. Particularly preferred anionic polymers are formed from monomers selected from ethylenically unsaturated carboxylic acid and sulphonic acid monomers, preferably selected from (meth) acrylic acid, allyl sulphonic acid and 2-acrylamido-2-methyl propane sulphonic acid, and their salts, optionally in combination with non-ionic co-monomers, preferably selected from (meth) acrylamide, hydroxy alkyl esters of (meth) acrylic acid and N-vinyl pyrrolidone. Especially preferred polymers include the homopolymer of sodium acrylate, the homopolymer of acrylamide and the copolymer of sodium acrylate with acrylamide.

Preferred non-ionic polymers are formed from ethylenically unsaturated monomers selected from (meth) acrylamide, hydroxy alkyl esters of (meth) acrylic acid and N-vinyl pyrrolidone. Preferred cationic polymers are formed from ethylenically unsaturated monomers selected from dimethyl amino ethyl (meth) acrylate - methyl chloride, (DMAEA.MeCI) quat, diallyl dimethyl ammonium chloride (DADMAC), trimethyl amino propyl (meth) acrylamide chloride (ATPAC) optionally in combination with non-ionic co-monomers, preferably selected from (meth) acrylamide, hydroxy alkyl esters of (meth) acrylic acid and N-vinyl pyrrolidone.

In the invention, the polymer may be formed by any suitable polymerisation process. The polymers may be prepared for instance as gel polymers by solution polymerisation, water-in-oil suspension polymerisation or by water-in-oil emulsion polymerisation. When preparing gel polymers by solution polymerisation the initiators are generally introduced into the monomer solution.

Optionally a thermal initiator system may be included. Typically a thermal initiator would include any suitable initiator compound that releases radicals at an elevated temperature, for instance azo compounds, such as azo-bis-isobutyronitrile. The temperature during polymerisation should rise to at least 70° C. but preferably below 95° C. Alternatively polymerisation may be effected by irradiation (ultra violet light, microwave energy, heat etc.) optionally also using suitable radiation initiators. Once the polymerisation is complete and the polymer gel has been allowed to cool sufficiently the gel can be processed in a standard way by first comminuting the gel into smaller pieces, drying to the substantially dehydrated polymer followed by grinding to a powder.

Such polymer gels may be prepared by suitable polymerisation techniques as described above, for instance by irradiation. The gels may be chopped to an appropriate size as required and then on application mixed with the material as partially hydrated water soluble polymer particles.

The polymers may be produced as beads by suspension polymerisation or as a water-in-oil emulsion or dispersion by water-in-oil emulsion polymerisation, for example according to a process defined by EP-A-150933, EP-A-102760 or EP-A-126528.

Alternatively the water soluble polymer may be provided as a dispersion in an aqueous medium. This may for instance be a dispersion of polymer particles of at least 20 microns in an aqueous medium containing an equilibrating agent as given in EP-A-170394. This may for example also include aqueous dispersions of polymer particles prepared by the polymerisation of aqueous monomers in the presence of an aqueous medium containing dissolved low IV polymers such as poly diallyl dimethyl ammonium chloride and optionally other dissolved materials for instance electrolyte and/or multi-hydroxy compounds e.g. polyalkylene glycols, as given in WO-A-9831749 or WO-A-9831748.

The aqueous solution of water-soluble polymer is typically obtained by dissolving the polymer in water or by diluting a more concentrated solution of the polymer. Generally solid particulate polymer, for instance in the form of powder or beads, is dispersed in water and allowed to dissolve with agitation. This may be achieved using conventional make up equipment. Desirably, the polymer solution can be prepared using the Auto Jet Wet (trademark) supplied by Ciba Specialty Chemicals. Alternatively, the polymer may be supplied in the form of a reverse phase emulsion or dispersion which can then be inverted into water.

1. A process of forming an aqueous suspension, the process comprising:
adding an organic polymeric flocculant to a first aqueous suspension of solid particles, thereby forming a suspension comprising a flocculated solid,
allowing the flocculated solid to settle in a vessel, thereby forming to a bed comprising a consolidated solid, and
introducing an effective amount of an agent, into the bed comprising the consolidated solid or into the flocculated solid, thereby forming a second aqueous suspension,
wherein the second aqueous suspension of solid particles has a higher solids content than the first aqueous suspension of solid particles,
the agent is a free radical agent, an oxidizing agent, or both, and,
introducing the agent comprises introducing the agent with a rake suitable for conveying the agent, introducing the agent through a conduit entering through a top of the vessel, introducing the agent through an aperture or conduit in a side wall of the vessel, introducing the agent through an aperture or conduit in a base of the vessel, introducing the agent through an aperture or conduit in a feed line conveying the bed comprising a consolidated solid from a base of the vessel, introducing the agent through a sparge, or any combination thereof.

2. The process of claim 1, wherein the agent is a perborate, a percarbonate, a persulphate, an ozone, a peroxide, or any combination thereof.

3. The process of claim 1, wherein the agent is ozone water or hydrogen peroxide.

4. The process of claim 1, wherein a yield stress of a layer of solid produced with the agent is at least 30% below a yield stress of a layer of solid at an equivalent solid content produced without introducing the agent.

5. The process of claim 1, wherein a solid content by weight of a layer produced with the agent is greater by at least 5% than a solid content by weight of a layer having an identical yield stress from an equivalent process without introducing the agent.

6. The process of claim 1, further comprising:
releasing water from the suspension,
wherein introducing the effective amount of the agent into the bed comprising the solid increases a solid content of the bed compared to an equivalent process without the agent.

7. The process of claim 1, wherein the vessel is a gravimetric thickener.

8. The process of claim 1,
wherein the vessel comprises a feedwell, (3) and
the forming the suspension comprising a flocculated solid and the allowing the flocculated solid to settle are each in the feedwell.

9. The process according of claim 8, wherein the introducing the agent comprises introducing the agent into the flocculated solid settling in the feedwell.

10. The process of claim 1,
wherein the aqueous second suspension forms an underflow, and
the process further comprises transferring the underflow either to a disposal area or to a mineral processing operation.

11. The process of claim 1, wherein the first aqueous suspension of solid particles comprises mineral particles.

12. The process of claim 1,
wherein the first aqueous suspension of solid particles is derived from a mineral or energy processing operation, a tailing substrate, or both, and
the first aqueous suspension of solid particles is at least one selected from the group consisting of bauxite, a base metal, a precious metal, iron, nickel, coal, a mineral sand, an oil sand, china clay, diamond, and uranium.

13. The process of claim 1, wherein the organic polymeric flocculant is a nonionic or anionic polymer that is either a synthetic polymer of intrinsic viscosity of at least 4 dl/g or a natural polymer.

14. The process of claim 1, wherein the organic polymeric flocculant is selected from the group consisting of a homopolymer of sodium acrylate, a homopolymer of acrylamide, and a copolymer of acrylamide and sodium acrylate.

15. The process of claim 1, wherein introducing the agent comprises introducing the agent through an aperture or conduit in a feed line conveying the bed between a base of the vessel and a pump.

16. The process of claim 4, wherein the yield stress of the layer of solid produced with the agent is at least 50% below the yield stress of the layer of solid at the equivalent solid content produced without introducing the agent.

17. The process of claim 1, wherein the agent is an aqueous solution with a hydrogen peroxide content of at least 20%.

18. The process of claim 1, wherein the agent is ozone water with a concentration of at least 0.1 ppm.
